(19) United States
(12) Patent Application Publication
(10) Pub. No.: US 2015/0197118 A1
(43) Pub. Date: Jul. 16, 2015

(54) AROMA DISPERSING WRITING INSTRUMENT

(71) Applicant: Les Wagenheim, Pepper Pike, OH (US)

(72) Inventor: Les Wagenheim, Pepper Pike, OH (US)

(21) Appl. No.: 14/156,079

(22) Filed: Jan. 15, 2014

(51) Int. Cl. B43K 29/20; B43K 15/00

(52) U.S. Cl. CPC B43K 29/20; B43K 15/00

(57) ABSTRACT

A writing instrument includes a writing portion having a conventional writing implement and an aroma carrier separated from direct contact with a user. The aroma carrier is configured to allow release of the aroma to the user. The aroma carrier is separated from the writing portion by a divider that prevents fluid communication between the aroma carrier and the writing portion. The writing instrument may disperse any preferred aroma from the aroma carrier.

### TECHNICAL FIELD

The present disclosure relates generally to writing instruments, and more particularly to writing instruments that disperse aroma for aroma therapy.

### BACKGROUND

Writing instruments such as pencils, pens, markers, highlighters, etc. are used to mark various surfaces. These instruments often incur daily usage and typically include a writing portion coupled to a barrel. In some instances, such writing instrument may include an aroma-releasing barrel or other portion of the instrument coming into contact with the user. In such case, the aroma may transfer to the user and/or clothing and/or the aroma may not be appealing to the user. It would be helpful if a writing instrument instead included a user-chosen aroma with an aroma-releasing portion not coming into direct contact with the user.

### SUMMARY

The present disclosure relates to a writing instrument including a writing portion having a conventional writing implement and an aroma carrier separated from direct contact with a user. The aroma carrier is configured to allow release of the aroma to the user. The aroma carrier is separated from the writing portion by a divider that substantially prevents fluid communication between the aroma carrier and the writing portion. The writing instrument may disperse any preferred aroma from the aroma carrier.

According to one aspect, a writing instrument includes an elongate barrel including separated upper and lower chambers, a writing portion coupled to the barrel and in communication with the lower chamber, the writing portion including a conventional writing implement, a dispersing rod in at least part of the upper chamber, the dispersing rod configured to receive and to disperse an aromatic composition, and a retainer configured to retain the dispersing rod at least partially within the upper chamber.

The writing instrument may further include a divider for separating the upper and lower chambers from one another, the divider configured to prevent fluid interaction between the chambers. The divider may be configured to prevent contact of the dispersing rod with the writing portion. The dispersing rod may extend beyond the upper chamber and at least partially into the retainer. The dispersing rod may be retained at least partially within the upper chamber by a friction fit and is removable in response to sufficient force.

The retainer may be removably coupled to the elongate barrel. The retainer may include an aeration portion configured to allow passing of aroma from the dispersing rod. The retainer may be outwardly radially spaced from the dispersing rod.

The writing instrument may further include a radially inwardly extending protrusion configured to resist movement of the dispersing rod. The dispersing rod may be friction fit with the protrusion. The retainer may be removably coupled to the barrel and the protrusion may be fixed to the barrel.

The writing instrument may further include an aromatic composition dispersed by the dispersing rod, wherein the aromatic composition is an essential oil.

According to another aspect, a writing instrument includes an elongate barrel axially extending between an upper axial end and a lower axial end, the barrel defining an upper chamber opening to the upper axial end, a writing portion removably coupled to the lower axial end of the barrel, wherein the writing portion is fluidly separated from the upper chamber, a dispersing rod removably inserted into the upper chamber, the dispersing rod configured to receive and to disperse an aromatic composition, a retainer configured to retain the dispersing rod within the upper chamber; and an aeration portion configured to allow passing of aroma from the dispersing rod.

The writing instrument may further include a divider configured to fluidly separate the upper chamber from the writing portion. The writing instrument may further include a radially inwardly extending protrusion configured to resist movement of the dispersing rod. The retainer may be removably coupled to the barrel and the protrusion may be fixed to the barrel.

According to yet another aspect, a method of delivering aroma therapy diffusion may include the steps of inserting a dispersing rod into an upper chamber of a writing instrument, wherein the upper chamber is defined by an elongate barrel of the writing instrument, transferring an aromatic composition to the dispersing rod from an external source, and coupling a retainer to the barrel to prevent removal of the dispersing rod.

The method may further include the step of passing aroma from the dispersing rod through apertures of the retainer. The method may further include the steps of removing the retainer, withdrawing the dispersing rod from the chamber, inserting another dispersing rod into the chamber, and recoupling the retainer to the barrel. The method may further include the step of fluidly separating the upper chamber of the elongate barrel from a writing portion of the writing instrument via a divider.

The foregoing and other features are hereinafter described in greater detail with reference to the accompanying drawings.

### BRIEF DESCRIPTION OF THE DRAWINGS

FIG. 1 is a side elevation view of an exemplary writing instrument.

FIGS. 2A-2C are partial cross-sectional views of the writing instrument of FIG. 1.

FIG. 3 is a perspective view of the writing instrument of FIG. 1.

FIG. 4 is an exploded view of the writing instrument of FIG. 1.

FIG. 5 is a top elevation view of the writing instrument of FIG. 1.

FIG. 6 is a front elevation view of the writing instrument of FIG. 1.

### DETAILED DESCRIPTION

The principles of the present disclosure have general application to writing instruments, and particular application to a pen that disperses an aroma, herein also referred to as fragrance or scent, for aroma therapy. The writing instrument will be described below by way of example in this context. The writing instrument may be suitable for use in delivering aroma therapy, such as in dispersing an aroma to a room or in masking an odor, both during use of the writing instrument and during its storage in a drawer, purse, pocket, etc. It will of course be appreciated, and also understood, that the principles of the disclosure may be useful in other writing implement applications including in markers, highlighters, pencils, etc.

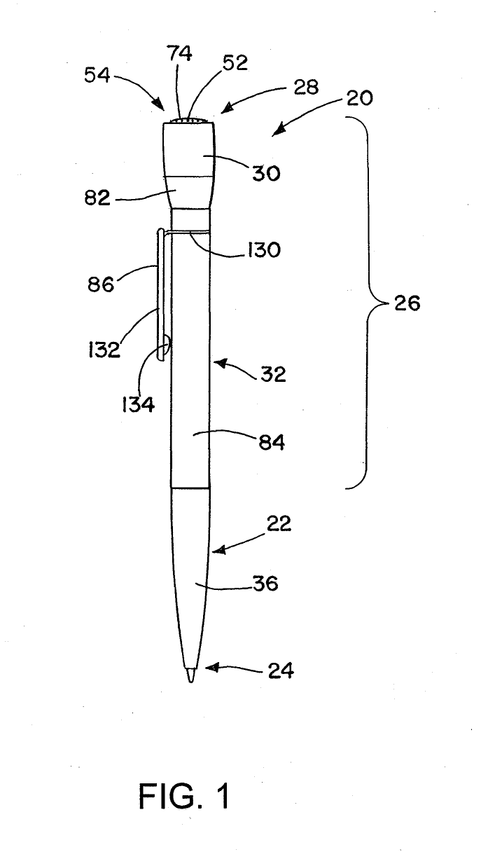

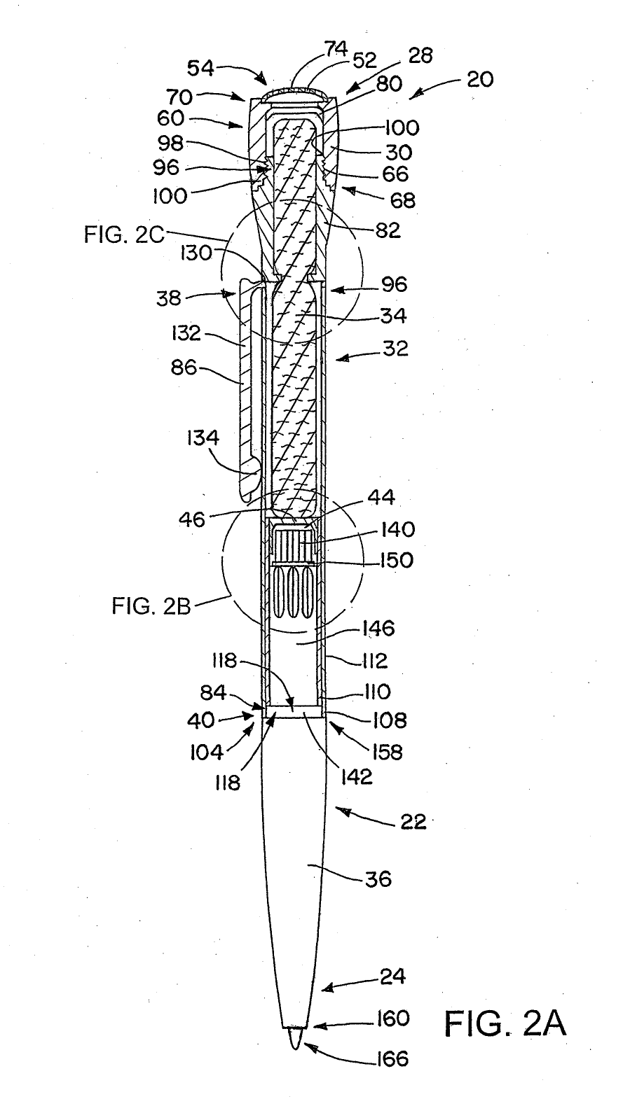

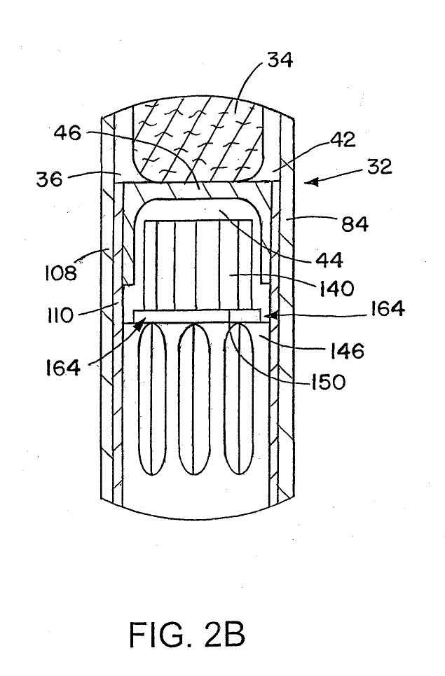

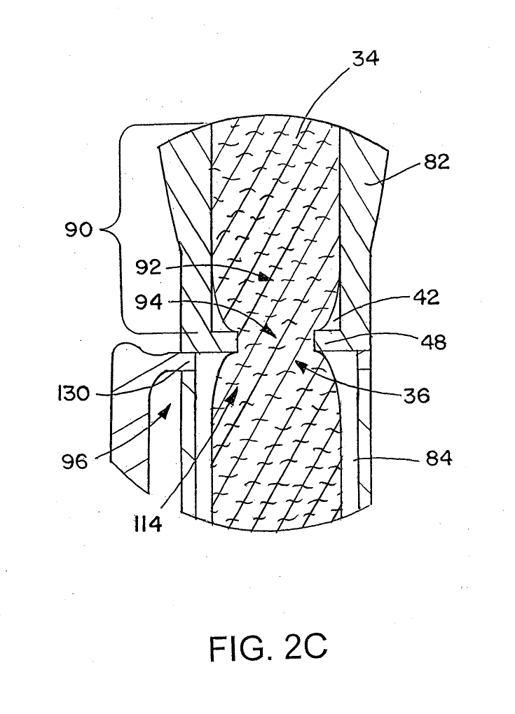

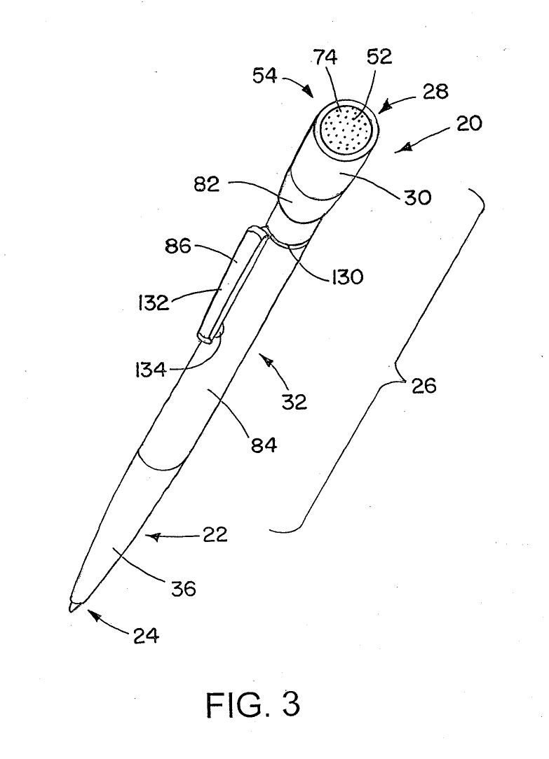

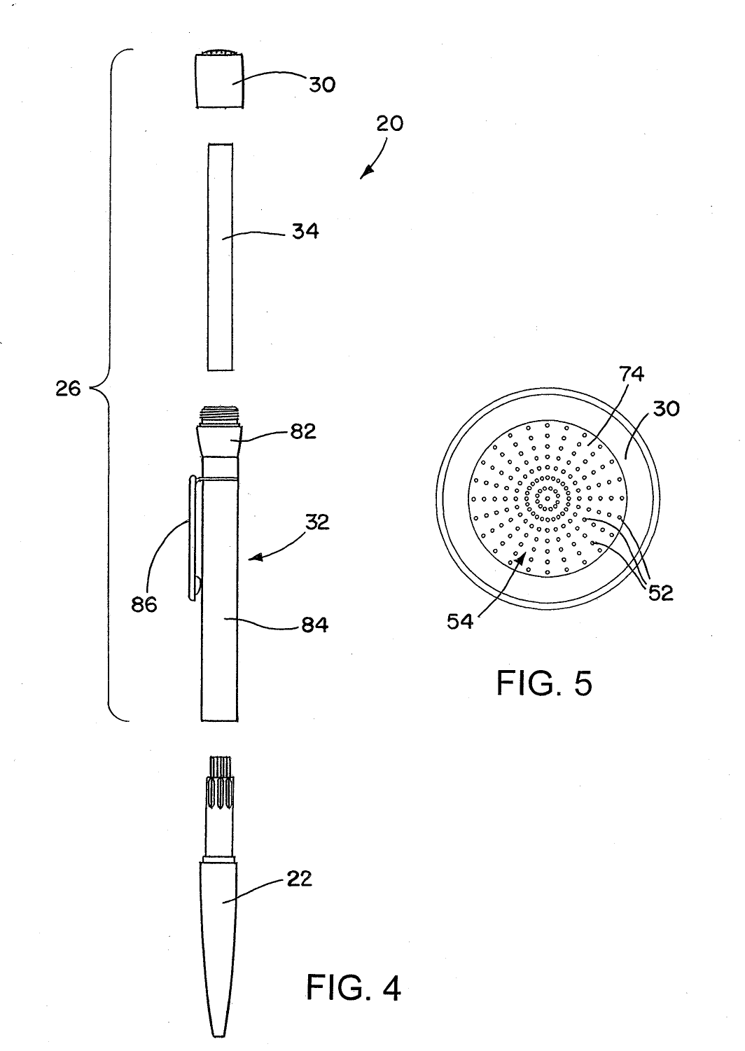

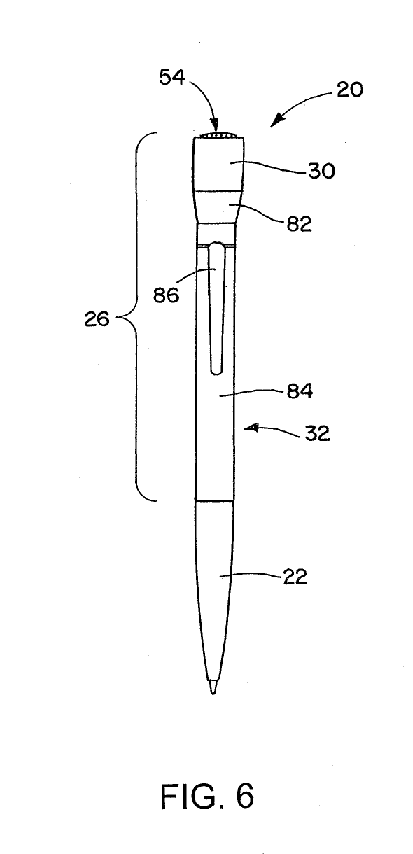

Referring now to the drawings in detail, and initially to FIGS. 1-6, an exemplary writing instrument, such as a pen 20, is illustrated. The pen 20 is of an elongate shape that is similar to the shape of a conventional ball point pen. It will be appreciated that the pen 20 may be of another suitable shape. The pen 20 includes a writing portion 22, disposed at a pen lower end 24, and an aroma dispersing portion 26, disposed at a pen upper end 28. The writing portion 22 is configured to mark on surfaces, while the aroma dispersing portion 26 is configured to disperse an aromatic composition having an aroma. The aroma dispersing portion 26 may be coupled to the writing portion 22. It will herein be appreciated that coupling may be either direct or indirect.

The aroma dispersing portion 26 includes a retainer, such as a retainer cap 30, a hollow elongate barrel 32, and an aroma carrier, such as an aroma dispersing rod 34. The barrel 32 defines a barrel through-passage 36 extending between a barrel upper end 38 and a barrel lower end 40. The barrel through-passage 36 is divided into an upper chamber 42 and a lower chamber 44 by a divider 46 of the barrel 32. The divider 46 separates, such as fluidly separates, the upper and lower chambers 42, 44 from one another. It will be appreciated that fluid separation herein includes gaseous separation, liquid separation, and any combination thereof.

The aroma dispersing rod 34 is at least partially retained in the upper chamber 42. The dispersing rod 34 may be in contact with the divider 46 when the dispersing rod 34 is fully seated into the upper chamber 42. A portion of the dispersing rod 34 may extend beyond the upper chamber 42 and into the retainer cap 30, which is coupled to the barrel 32. In this way, the dispersing rod 34 is retained in the upper chamber 42 by the retainer cap 30. The dispersing rod 34 may be also retained in the upper chamber 42 by a friction fit, also herein referred to as a tolerance fit or a compression fit, with a boss of the barrel 32. The boss, such as an annular protrusion 48, may extend radially inward from an inner surface 50 of the barrel 32. Alternatively, the boss may be of any other suitable shape. The friction fit may be configured to resist movement of the dispersing rod 34.

The dispersing rod 34 is configured to receive, retain, and disperse an aromatic composition, such as an essential oil, perfume, or cologne. The retaining may include absorption or other carrying of the aromatic composition. The dispersing rod 34 may be made of a compressed fibrous material, such as cotton, having suitable absorption, retaining, and/or dispersion properties. Essential oils or other aromatic compositions may be transferred to, for example absorbed by, the dispersing rod 34 after inserting of the dispersing rod 34 into the upper chamber 42. Alternatively, aromatic compositions may be transferred to the dispersing rod 34 prior to inserting the dispersing rod 34 into the upper chamber 42. The retainer cap 30 may then be coupled, such as screwed onto, the elongate barrel 32, thereby preventing inadvertent removal of the dispersing rod 34 from the upper chamber 42. The retainer cap 30 is configured to allow passing of aroma from the dispersing rod 34 to the user. For example, upon contact with oxygen or other gases in the atmosphere, the aromatic composition transferred to the dispersing rod 34 may begin to disperse through apertures 52 of an aeration portion 54 of the retainer cap 30. In this way, the aroma dispersing portion 24 may provide aroma therapy to the user of the pen 20.

Additional aromatic composition may be added by removing the retainer cap 30, transferring the additional aromatic composition to the dispersing rod 34, and then re-coupling the retainer cap 30 to the barrel 32. Alternatively, a substitute dispersing rod, configured to receive the same or a different aromatic composition, may be exchanged with a dispersing rod 34 already inserted into the pen 20. The dispersing rods may be exchanged by again removing the retainer cap 30. In the case that the dispersing rod 34 is configured to extend beyond the upper chamber 42, it may be easily gripped for removal from the upper chamber 42 when the retainer cap 30 is not coupled to the barrel 32. To remove the current dispersing rod 34, the current dispersing rod 34 may be withdrawn with sufficient force to overcome the friction fit with the protrusion 48. Then the substitute dispersing rod may be inserted into the upper chamber 42 and the retainer cap 30 re-coupled to the elongate barrel 32.

The dispersing rod 34 of the pen 20 provides flexibility to a user as compared to conventional essential oil containers in combination with conventional wicks. Conventional essential oil containers may only be found in a limited assortment of aromas, which may not be pleasant or therapeutic to the user. Further, only certain containers, containing a limited assortment of aromas, may be sized for use with conventional writing instruments requiring use of the certain containers. On the other hand, any aromatic composition from any external source, such as a user's preferred cologne or perfume, may be transferred to a dispersing rod 34 of the pen 20. In this way, a user may have the flexibility to freely choose the aroma dispersed from the pen 20.

Referring now in greater detail to the aroma dispersing portion 26, the retainer cap 30 is outwardly radially spaced, and also axially spaced, from the dispersing rod 34 so as to not transfer an aromatic composition of the dispersing rod 34 to the retainer cap 30. The retainer cap 30 includes a retainer tubular section 60 and an aeration portion 62. The retainer tubular section 60 is open at a retainer lower end 68, such as for receiving at least part of the dispersing rod 34. The tubular section 60 is also at least partially closed at a retainer upper end 70 via the aeration portion 54. Due to the configuration of the aeration portion 62, an aroma from the aromatic composition is substantially directed through the aeration portion 62 in order to maintain concentrated dispersion, such as towards olfactory senses of the user. While allowing passing of aroma to the user, the aeration portion 62 also substantially prevents direct contact of the dispersing rod 34 and aromatic composition contained therein with the writing instrument's user.

As shown, the aeration portion 54 includes a screen 74 having a plurality of the apertures 52. The apertures 52 extend through the screen 74. The apertures 52 are shaped, such as circular-shaped, for ease of manufacturing. The aeration portion 54 further includes a coupling ring 80 for coupling the screen 74 to the retainer tubular section 60. For example, the coupling ring 80 may be coupled to an internal surface 64 of the retainer tubular section 60, such as by a weld, adhesive, friction fit, or other suitable attachment. A surface, such as the internal surface 64, of the retainer tubular section 60 may also include threads 66 for enabling coupling to the barrel upper end 38 of the barrel 32. It will also be appreciated by one of ordinary skill that the retainer cap 30 may be coupled by other suitable mechanical interaction to the barrel 32, such as by a snap fit or a friction fit.

The retainer 30 may also include an alternative aeration portion including a screen having apertures of greater or lesser diameter, or even different size, than the apertures 52. Alternatively, the screen 74 may be replaced with a mesh or woven synthetic or metal material. Further, it will be appreciated that a user may alternate between retainer caps having differently sized or shaped apertures in order to change the quantity of aroma dispersing from the aroma dispersing rod 34 of the pen 20.

Referring now to the barrel 32, included is a barrel retaining section 82 disposed at the barrel upper end 38 and a barrel tubular section 84 disposed at the barrel lower end 40. A clip 86 may be disposed, such as coupled, between each of the barrel retaining section 82 and the barrel tubular section 84. The barrel retaining section 82, barrel tubular section 84, and clip 86 may be fixedly coupled to one another via a weld, adhesive, or other suitable attachment. Alternatively, it will be appreciated that the barrel 32 may instead be a unitary component, rather than separate fixedly coupled components. Any of the barrel retaining section 82, barrel tubular section 84, and clip 86 may also be removably coupled to one another rather than fixedly coupled to one another.

The barrel retaining section 82 includes the protrusion 48. As shown, the protrusion 48 may be an annular, radially inwardly extending boss. The protrusion 48 may also extends axially along a portion of an internal length 90 of the barrel retaining section 82. The protrusion 48 forms part of a through-passage 92 extending through the retaining section 82. The protrusion 48 defines a protrusion passage 94 that is radially smaller in size than an uncompressed outer diameter of the aroma dispersing rod 34, thereby allowing the protrusion 48 to retain the dispersing rod 34 via a friction fit with the dispersing rod 34. The protrusion 48 serves as a retainer for the dispersing rod 34, in addition to the retainer cap 30, and is configured to substantially resist and/or substantially prevent movement of the dispersing rod 34. The barrel retaining section 82 also has a radially outwardly tapered outer shape, although another shape may also be suitable, such as a cylindrical outer shape. An upper end 96 of the barrel retaining section 82 may include threads, such as external threads 98 on an outer surface 100 of the barrel retaining section 82. The threads 98 may enable threaded coupling of the barrel 32 to the retainer cap 30. Additionally, a lower end 104 of the barrel retaining section 82 may be coupled directly to the clip 86 and indirectly to the barrel tubular section 84. Alternatively, the barrel retaining section 82 may be instead directly coupled to the barrel tubular section 84.

Like the barrel retaining section 82, the barrel tubular section 84 is also configured to retain the dispersing rod 34. The barrel tubular section 84 includes an outer sleeve 108, an inner sleeve 110, and the divider 46. The inner sleeve 110 is disposed radially inwardly in relation to the outer sleeve 108. An outer surface 112 of the outer sleeve 108 may be decorated, for example by paint or by an overlay attached, such as adhesively attached, to the outer surface 112. The outer and inner sleeves 108, 110 at least partially define the upper and lower chambers 42, 44 of the barrel 32.

The divider 46 is disposed radially inwardly in relation to the inner sleeve 110. The divider 46, outer sleeve 108, and inner sleeve 110 may be fixedly coupled to one another via a weld, adhesive, or other suitable attachment. Alternatively, the divider 46 may be integral with either of the outer sleeve 108 or inner sleeve 110, or the divider 46 may be removably coupled to, such as friction fit with, the barrel tubular section 84. As discussed, the divider 46 is configured to fluidly separate the upper and lower chambers 42, 44. The divider 46 may be impermeable and may not include apertures. It will herein be understood that fluid separation may include gaseous separation, liquid separation, or any combination thereof.

The upper chamber 42 is further defined by the barrel retaining section 80, and thereby includes the through-passage 92 extending through the retaining section 82. The upper chamber 42 opens to the upper end 96 of the barrel retaining section 82 at an upper opening 114. The upper opening 114 receives the dispersing rod 34. As shown, the upper opening 114 is radially larger in size than the protrusion passage 94, and also radially larger in size than the outer diameter of the dispersing rod 34.

The lower chamber 44 opens to the lower end 104 of the barrel tubular section 84 at a lower opening 118. The writing portion 22 is removably coupled to the barrel lower end 40, and thereby to the lower end 104 of the barrel retaining section 82. The lower chamber 44 is configured to receive and retain at least a portion of the writing portion 22. The writing portion 22 may be removably retained via a friction fit, herein also referred to as a deformation fit or a tolerance fit, between the writing portion 22 and the inner sleeve 110. Additionally, because the divider 46 substantially prevents fluid communication between the upper and lower chambers 42, 44, the divider also substantially prevents fluid communication between the upper chamber 42 and the writing portion 22. The dispersing rod 34 and any aromatic composition contained therein, such as essential oil, will also be fluidly separated from contact with the writing portion 22 via the divider 46. In this way, the aromatic composition contained therein is substantially prevented from being transferred to the writing portion 22.

One of ordinary skill will realize that the essential oil may contain acidic or corrosive chemicals. Each surface in contact with the dispersing rod 34 may be coated or made from a material, such as stainless steel or nickel, that is not susceptible to chemical interaction with such an essential oil. These surfaces may include the surfaces defining the upper chamber 42 of the elongate barrel 32, such as surfaces of the outer and inner sleeves 108, 110, and surfaces of the barrel retaining section 82, such as surfaces of the protrusion 48 and also additional inner surfaces of the barrel retaining section 82.

Turning now to the clip 86, the pen 20 may be configured to removably attach to an external surface, such as to a user's clothing, via the clip 86. The clip 86 is configured to flex, such as elastically outwardly, in relation to the barrel tubular section 84. The clip 86 includes a clip ring 130 for coupling to at least one of the barrel tubular section 84 or the barrel retaining section 82. The clip ring 130 may be coupled to outer surfaces of at least one of the barrel tubular section 84 or the barrel retaining section 82, or the clip ring 130 may be coupled between, such as interposed between, the barrel tubular section 84 and the barrel retaining section 82. In the case that the clip ring 130 is interposed between the barrel tubular section 84 and the barrel retaining section 82, the clip ring 130 may define at least a portion of the upper chamber 42. As shown, the clip 86 may also include an extension member 132 and a rounded boss 134 extending from the extension member 132. The extension member 132 and the boss 134 may be configured to allow the clip 86 to removably attach to external surfaces. The extension member 132 may be spaced, such as radially spaced, from the outer surface 112 of the outer sleeve 108. The rounded boss 134 extends from the extension member 132 towards the outer surface 112 and may be in direct contact with the outer surface 112.

Turning next to the writing portion 22, the writing portion 22 includes a holding sleeve 136, ink pen refill 140, lower marking section 142, upper marking section 146, and motion transfer mechanism 150. The holding sleeve 136 extends between a holding sleeve upper end 158 and a holding sleeve lower end 160. The holding sleeve 136 is configured to receive a conventional writing implement, such as the ink pen refill 140. The holding sleeve 136 is also configured to be held and gripped by a user during writing. The lower marking section 142 is coupled to, such as fixedly received in, the holding sleeve upper end 158. The lower marking section 142 is substantially prevented from rotating relative to the holding sleeve 136. The lower marking section 142 is configured to receive and rotatably retain the upper marking section 146. The motion transfer mechanism 150 is received in and movably coupled to each of the upper and lower marking sections 146, 142. The ink pen refill 140 is coupled, for example threadedly coupled, to an upper end 164 of the motion transfer mechanism 150. Additionally, the upper marking section 146 of the writing portion 22 is removably coupled to the barrel 32, such as at least partially received and retained in the lower chamber 44 of the barrel 32. Alternatively, the writing portion 22 may be otherwise coupled to the barrel 32, such as by threads or a snap fit.

Rotation of the holding sleeve 136, and also of the lower marking section 142, relative to the upper marking section 146 causes axial motion of the motion transfer mechanism 150. The motion transfer mechanism 150 and the pen refill 140 are axially moved together within the upper and lower marking sections 146, 142 towards the pen lower end 24 of the pen 20. A lower writing end 166 of the pen refill 140 is thereby extended or retracted from the holding sleeve lower end 160 of the holding sleeve 36.

In use, the barrel 32 is held by a user to prevent the barrel 32 from rotating, while rotation of the holding sleeve 136 in a first direction causes extension of the pen refill 140 from the holding sleeve lower end 160. Retraction of the pen refill 140 may occur via an opposite rotation of the holding sleeve 136 relative to the barrel 32. One of ordinary skill will also realize that the writing portion 22 may instead include a suitable alternative mechanism configured to extend and retract the ink pen refill 40, such as a pin and spring mechanism (not shown). It will also be appreciated that the writing portion 22 may include multiple ink pen refills or may instead include a marker member, a pencil member, a highlighter member, etc. It will further be appreciated that the ink pen refill 140 may not be capable of extension and retraction, and that the pen 20 may include a cap (not shown) for preventing inadvertent marking of surfaces when the pen 20 is not being used.

Although a writing instrument has been shown and described with respect to a certain embodiment or embodiments, it will be appreciated that equivalent alterations and modifications will occur to others skilled in the art upon the reading and understanding of this specification and the annexed drawings. For example, with regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments. In addition, while a particular feature may have been described above with respect to only one or more of several illustrated embodiments, such feature may be combined with one or more other features of the other embodiments, as may be desired and advantageous for any given or particular application.

1. A writing instrument comprising:
an elongate barrel including separated upper and lower chambers;
a writing portion coupled to the barrel and in communication with the lower chamber, the writing portion including a conventional writing implement;
a dispersing rod in at least part of the upper chamber, the dispersing rod configured to receive and to disperse an aromatic composition; and
a retainer configured to retain the dispersing rod at least partially within the upper chamber.

2. The writing instrument of claim 1, further comprising a divider for separating the upper and lower chambers from one another, the divider configured to prevent fluid communication between the chambers.

3. The writing instrument of claim 1, wherein the divider is configured to prevent contact of the dispersing rod with the writing portion.

4. The writing instrument of claim 1, wherein the dispersing rod extends beyond the upper chamber and at least partially into the retainer.

5. The writing instrument of claim 1, wherein the dispersing rod is retained at least partially within the upper chamber by a friction fit and is removable in response to sufficient force.

6. The writing instrument of claim 1, wherein the retainer is removably coupled to the elongate barrel.

7. The writing instrument of claim 1, wherein the retainer includes an aeration portion configured to allow passing of aroma from the dispersing rod.

8. The writing instrument of claim 1, wherein the retainer is outwardly radially spaced from the dispersing rod.

9. The writing instrument of claim 1, further comprising a radially inwardly extending protrusion configured to resist movement of the dispersing rod.

10. The writing instrument of claim 9, wherein the dispersing rod is friction fit with the protrusion.

11. The writing instrument of claim 1, wherein the retainer is removably coupled to the barrel and the protrusion is fixed to the barrel.

12. The writing instrument of claim 1, further comprising an aromatic composition dispersed by the dispersing rod, wherein the aromatic composition is an essential oil.

13. A writing instrument comprising:
an elongate barrel axially extending between an upper axial end and a lower axial end, the barrel defining an upper chamber opening to the upper axial end;
a writing portion removably coupled to the lower axial end of the barrel, wherein the writing portion is fluidly separated from the upper chamber;
a dispersing rod removably inserted into the upper chamber, the dispersing rod configured to receive and to disperse an aromatic composition;
a retainer configured to retain the dispersing rod within the upper chamber; and
an aeration portion configured to allow passing of aroma from the dispersing rod.

14. The writing instrument of claim 13, further comprising a divider configured to fluidly separate the upper chamber from the writing portion.

15. The writing instrument of claim 13, further comprising a radially inwardly extending protrusion configured to resist movement of the dispersing rod.

16. The writing instrument of claim 15, wherein the retainer is removably coupled to the barrel and the protrusion is fixed to the barrel.

17. A method of delivering aroma therapy diffusion, the method comprising the steps of:
inserting a dispersing rod into an upper chamber of a writing instrument, wherein the upper chamber is defined by an elongate barrel of the writing instrument;
transferring an aromatic composition to the dispersing rod from an external source; and
coupling a retainer to the elongate barrel to prevent removal of the dispersing rod.

18. The method of claim 17, further comprising the step of passing aroma from the dispersing rod through apertures of the retainer.

19. The method of claim 17, further comprising the steps of:
removing the retainer;
withdrawing the dispersing rod from the chamber;
inserting another dispersing rod into the chamber; and
recoupling the retainer to the barrel.

20. The method of claim 17, further comprising the step of fluidly separating the upper chamber of the elongate barrel from a writing portion of the writing instrument via a divider.
